(19) United States
(12) Patent Application Publication
(10) Pub. No.: US 2007/0260574 A1
(43) Pub. Date: Nov. 8, 2007

(54) METHOD FOR MANAGING FILES STORED IN A DIGITAL DEVICE

(76) Inventors: Hsin-Pao Kuan, Tao-Yuan Hsien (TW); Chih-Ling Wu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/745,453

(22) Filed: May 8, 2007

(30) Foreign Application Priority Data
May 8, 2006 (TW) 095116286

(51) Int. Cl. G06F 17/30; G06F 7/00

(52) U.S. Cl. 707/1; 707/5; 707/100; 707/102

(57) ABSTRACT

A digital device capable of utilizing a button to switch rapidly between file elements includes a memory for storing file elements, a selector module for selecting predetermined switch file elements from the file elements stored in the memory, the button for producing a switching signal, and a controller coupled to the button for switching from a state of having a first file element of the predetermined switch file elements open to a state of having a second file element of the predetermined switch file elements open corresponding to the switching signal received from the button.

### BACKGROUND OF THE INVENTION

1. Field of the Invention

The present invention relates to methods of performing file management in digital devices, and more particularly, to a method of utilizing a button group of a digital device to managing files stored in the digital device.

2. Description of the Prior Art

With the arrival of digital music, users can now enjoy a new type of music resource. Digital music can be stored in a relatively small digital file, and digital files can be stored in portable, non-volatile memory. Because of the ubiquity of digital music, portable music players, such as MP3 players, are now frequently seen. Generally speaking, different types of MP3 players can be distinguished by different types of memory adopted as media for storing the music data, and are typically separated into players that use flash memory and players that use hard disk drives for storing the music files. MP3 players that adopt flash memory are typically lighter and use relatively less power, but also suffer from lower capacity, which limits the amount of music data that can be stored in the MP3 players. For example, if the capacity of a flash memory based MP3 player is 64 MB, then the MP3 player can store approximately one hour of MP3-encoded digital music. To improve on the limited capacity of the flash memory based MP3 player, hard disk drive based MP3 players, which have much higher digital capacity, are being produced. Typical hard disk drive based MP3 players can store 1 GB, 5 GB, or even 40 GB of digital music data.

With the relatively large capacity of the MP3 players for storing the digital music data, the user can collect and categorize the large number of digital music files stored on the MP3 player to their own taste. However, users often prefer to listen to different types of music at different times or under different moods. Currently, the digital music files on the MP3 player can be selected by using a file navigation function, such that the user can use Up and Down buttons, or a jog dial, to select a file folder and music file for the song they want to hear. However, when the number of file folders and music files gets excessively large, the above-mentioned method becomes cumbersome and inefficient, and it is not a user-friendly file management method.

### SUMMARY OF THE INVENTION

According to the present invention, a method of managing files in a digital device having a button comprises establishing a plurality of file elements, selecting a plurality of predetermined switch file elements from the plurality of file elements, and switching from a first file element of the plurality of predetermined switch file elements to a second file element of the plurality of predetermined switch file elements when the button is pressed.

According to the present invention, a digital device capable of utilizing a button to switch rapidly between file elements comprises a memory for storing a plurality of file elements, a selector module for selecting a plurality of predetermined switch file elements from the plurality of file elements stored in the memory, a button for producing a switching signal, and a controller coupled to the button for switching from a state of having a first file element of the plurality of predetermined switch file elements open to a state of having a second file element of the plurality of predetermined switch file elements open corresponding to the switching signal received from the button.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a digital device according to the present invention.

FIG. 2 is a flow chart of performing file management in the digital device of FIG. 1.

FIG. 3 is a diagram of utilizing a computer to establish predetermined switch folders or files and a switch page link corresponding to a button group according to the present invention.

FIG. 4 is a diagram of using the button group to switch between file folders corresponding to the pages shown in FIG. 3.

### DETAILED DESCRIPTION

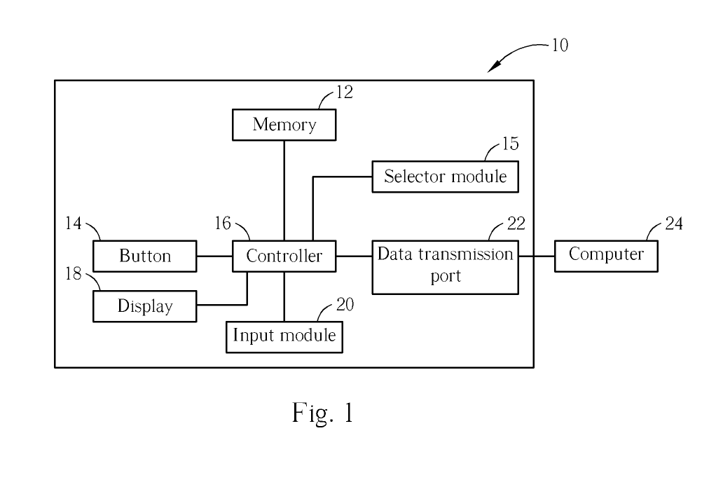

Please refer to FIG. 1, which is a functional block diagram of a digital device 10 according to the present invention. The digital device 10 can be an MP3 player, and comprises a memory 12 for storing a plurality of folders and files, a button group 14 for producing a switching signal, a selector module 15 for selecting a plurality of predetermined switch folders or switch files from the plurality of folders and files stored in the memory, and a controller 16 coupled to the memory and the button group. When the controller 16 receives the switching file transmitted from the button group 14, the controller 16 controls switching from a state of having a first file element of the plurality of predetermined switch folders and switch files open to a state of having a second file element of the plurality of predetermined switch folders and switch files open. The digital device 10 further comprises a display 18 coupled to the controller 16 for displaying a message corresponding to the folder or the file. When the controller 16 receives the switching signal transmitted from the button group 14, the controller 16 can be utilized to control the display 18 to switch from displaying a first folder page or a first file page of the plurality of predetermined switch folders or predetermined switch files to displaying a second folder page or a second file page of the plurality of predetermined switch folders or predetermined switch files. The digital device 10 further comprises an input module 20 for establishing the plurality of predetermined switch folders or predetermined switch files and a switch sequence link corresponding to the button group 14 on the digital device 10. The digital device 10 further comprises a data transmission port 22 for establishing a data transmission connection between the digital device 10 and an external computer 24. The computer 24 can also be used to establish the plurality of predetermined switch folders or predetermined switch files and the switch sequence link corresponding to the button group 14 on the digital device 10.

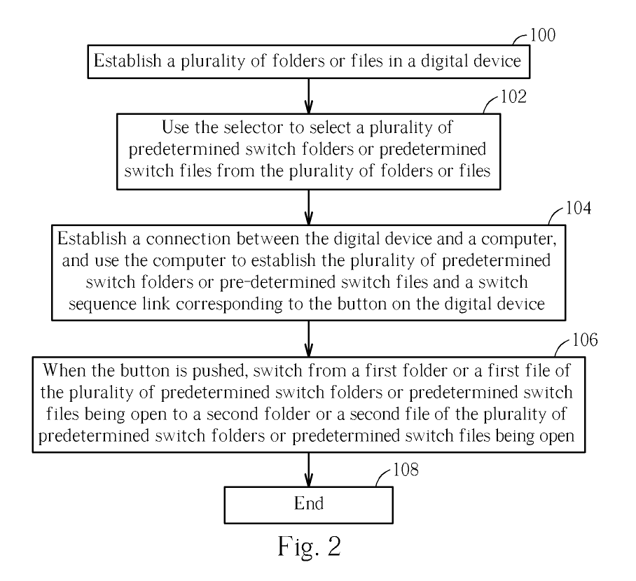

Please refer to FIG. 2, which is a flow chart diagram of performing file management in the digital device 10 according to the present invention, which comprises:

Step 100: Establishing the plurality of folders or files in the digital device 10, and storing the plurality of folders and files in the memory 12.

Step 102: Utilizing the selector module 15 to select the plurality of predetermined switch folders or predetermined switch files from the plurality of folders or files established in Step 100.

Step 104: Establishing a connection between the computer 24 and the digital device 10, and utilizing the computer 24 to establish the plurality of predetermined switch folders or predetermined switch files and the switch sequence link corresponding to the button group 14 in the digital device 10.

Step 106: When the button group 14 is pushed, switching from a first folder or a first file of the plurality of predetermined switch folders or predetermined switch files being open to a second folder or a second file of the plurality of predetermined switch folders or predetermined switch files being open.

Step 108: End.

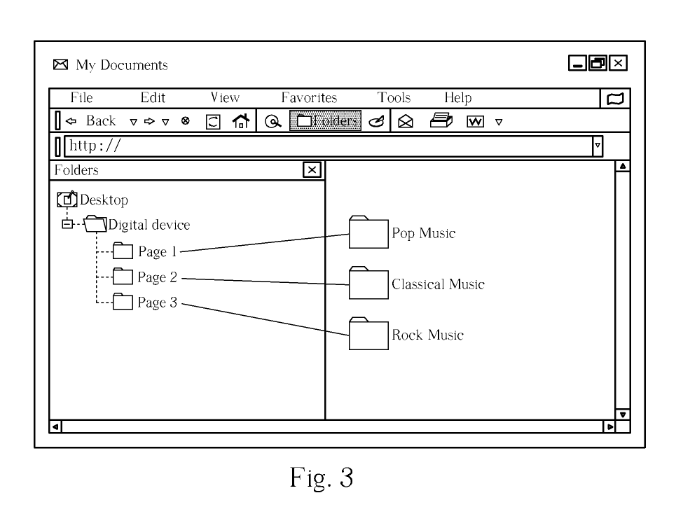

The following is a more detailed description of the steps listed above. First, the user can establish the plurality of folders or files in the digital device 10. The method of establishing the plurality of folder or files can be copying the plurality of folders or files from the computer 24 to the digital device 10, or using the digital device to produce the plurality of folders or files directly. The plurality of folders or files is stored in the memory 12. Then, the selector 15 can be used to select the plurality of predetermined switch folders or predetermined switch files from the plurality of folders or files established in Step 100. In other words, switching is only performed within the plurality of predetermined switch folders or predetermined switch files when the button group 14 is activated, and other folders or files will not be switched to. Then, the data transmission port 22 of the digital device 10 is used to establish a data transmission connection with the computer 24. The computer 24 can use the data transmission port 22 to establish the plurality of predetermined switch folders or predetermined switch files and the switch sequence link corresponding to the button group 14 on the digital device 10. For example, the computer 24 can establish the plurality of predetermined switch folders or predetermined switch files and the switch page link corresponding to the button group 14. Or, the input module 20 of the digital device 10 could be used to establish the plurality of predetermined switch folders or predetermined switch files and the switch sequence link corresponding to the button group 14 on the digital device 10. For example, please refer to FIG. 3, which is a diagram of using the computer 24 to establish the plurality of predetermined switch folders or predetermined switch files and the switch page link corresponding to the button group 14. Application software can be utilized in the computer 24 to set a first page of the digital device 10 to correspond to a folder called “Pop Music” stored in the memory 12, to set a second page of the digital device 10 to correspond to a folder called “Classical Music” stored in the memory 12, and to set a third page of the digital device 10 to correspond to a folder called “Rock Music” stored in the memory 12. Setting the link can be dragging the folder to a corresponding page. The plurality of predetermined switch folders or predetermined switch files and the switch page link corresponding to the button group 14 are not limited to the three pages mentioned above, but can be increased or decreased according to the requirements of the user.

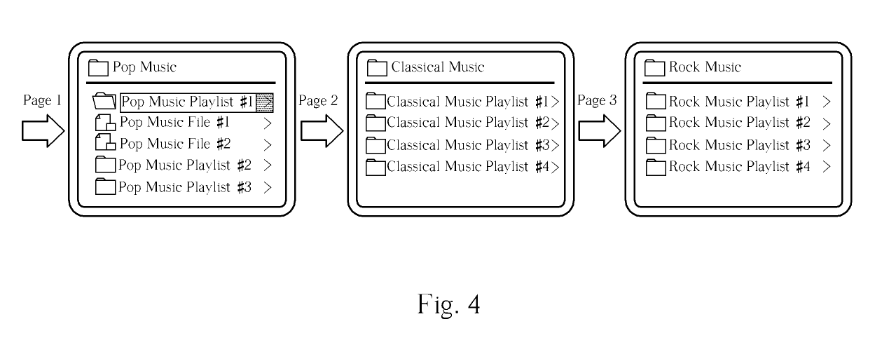

Switching of the first page, the second page, and the third page of the digital device 10 can correspond to manipulation of the button group 14. For example, when a page button of the button group 14 is pressed, the page button outputs a switching signal to the controller 16, and the controller 16 controls the display 18 to switch from displaying the first page to the second page, or from displaying the second page to the third page, or from displaying the third page back to the first page. In other words, the page switching operation is performed through the switching sequence of the first page, the second page, and the third page. The page button of the button group 14 is not limited to single-button manipulation. For example, if a forward button of the button group is pressed, the display can switch from the first page to the second page, from the second page to the third page, or from the third page back to the first page, thereby following the switching sequence of the first page, the second page, and the third page. If a back button of the button group is pressed, then the display can switch from the third page to the second page, from the second page to the first page, or from the first page to the third page, thereby following a switching sequence of the third page, the second page, and the first page. An example of utilizing the button group 14 to switch between the folders corresponding to the pages of FIG. 3 is illustrated in the diagram of FIG. 4. After switching to the Popular Music folder corresponding to the first page shown in FIG. 3, the controller 16 controls the display 18 to display folders or files in the Popular Music folder. The user can continue to open the subsequent folders or play one of the files. Likewise, after the button group 14 switches from displaying the first page to displaying the second page, the controller 16 controls the display 18 to display the folders or files in the Classical Music folder. Finally, when the button group 14 switches from displaying the second page to displaying the third page, the controller 16 controls the display 18 to display the folders or files in the Rock Music folder.

Beyond being able to set which folder stored in the memory 12 corresponds to which page, the user can also set which file stored in the memory 12 corresponds to which page. The file can be stored in a root directory, or stored in a single- or multi-layer folder. In the present invention, a page button of the button group 14 can be set to output a switch signal to the controller 16 when the page button is pressed, such that the controller 16 can switch from executing a file corresponding to a page to executing another file corresponding to a subsequent page, e.g. switching from playing a music file corresponding to the page to playing another music file corresponding to the subsequent page. Or, when a page button of the button group 14 is pressed, the page button can output a switch signal to the controller 16, and the controller 16 will switch from browsing a folder corresponding to one page to browsing a file corresponding to a subsequent page, or the controller 16 can switch from executing a file corresponding to the one page to browsing a folder corresponding to a second page.

Compared to the prior art method of switching between files or folders stored in a digital device, the present invention provides a method of utilizing a button of the digital device to switch rapidly between a file or a folder stored in the digital device. The present invention can be utilized in large capacity digital devices to provide users with a direct and fast method for browsing or executing folders or files, such as MP3 players, digital televisions, and digital set-top boxes. For application in MP3 players, the present invention allows the user to find and play with ease the digital music they desire to hear at any moment.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of managing files in a digital device having a button, the method comprising:
establishing a plurality of file elements;
selecting a plurality of predetermined switch file elements from the plurality of file elements; and
switching from a first file element of the plurality of predetermined switch file elements to a second file element of the plurality of predetermined switch file elements when the button is pressed.

2. The method of claim 1, wherein selecting the plurality of predetermined switch file elements from the plurality of file elements comprises establishing a connection between the digital device and a computer, and utilizing the computer to establish the plurality of predetermined file elements and a switch sequence connection corresponding to the button.

3. The method of claim 2, wherein selecting the plurality of predetermined switch file elements from the plurality of file elements further comprises utilizing the computer to establish the plurality of predetermined file elements and a switch page connection corresponding to the button.

4. The method of claim 1, wherein switching from the first file element of the plurality of predetermined switch file elements to the second file element of the plurality of predetermined switch file elements when the button is pressed comprises switching from displaying a first file element page of the plurality of predetermined switch file elements to displaying a second file element page of the plurality of predetermined switch file elements when the button is pressed.

5. The method of claim 1, wherein switching from the first file element of the plurality of predetermined switch file elements to the second file element of the plurality of predetermined switch file elements when the button is pressed comprises switching from executing a first file of the plurality of predetermined switch file elements to executing a second file of the plurality of predetermined switch file elements when the button is pressed.

6. A digital device capable of utilizing a button to switch rapidly between file elements, the digital device comprising:
a memory for storing a plurality of file elements;
a selector module for selecting a plurality of predetermined switch file elements from the plurality of file elements stored in the memory;
a button for producing a switching signal; and
a controller coupled to the button for switching from a state of having a first file element of the plurality of predetermined switch file elements open to a state of having a second file element of the plurality of predetermined switch file elements open corresponding to the switching signal received from the button.

7. The digital device of claim 6 further comprising a display, wherein the controller is utilized to control the display to switch from displaying a first file element page of the plurality of predetermined switch file elements to displaying a second file element page of the plurality of predetermined switch file elements when the controller receives the switching signal transmitted from the button.

8. The digital device of claim 6 further comprising an input module for establishing the plurality of predetermined switch file elements and a switching sequence link corresponding to the button on the digital device.

9. The digital device of claim 6 further comprising a data transmission port for performing a data transmission link with a computer, wherein the computer is utilized for establishing the plurality of predetermined switch file elements and a link of a switching sequence corresponding to the button on the digital device through the data transmission port.

10. The digital device of claim 6, wherein the controller is utilized for switching from executing a first file element of the plurality of predetermined switch file elements to executing a second file element of the plurality of predetermined switch file elements when the controller receives the switching signal transmitted from the button.

11. The digital device of claim 6, wherein the digital device is an MP3 player.

12. The digital device of claim 6, wherein the digital device is a digital TV.

13. The digital device of claim 6, wherein the digital device is a digital set-top box.
